(19) United States
(12) Patent Application Publication
(10) Pub. No.: US 2009/0202674 A1
(43) Pub. Date: Aug. 13, 2009

(54) DIET COMPOSITION AND METHOD OF PREPARING DIET-FOOD AND PET-FOOD THEREFROM

(76) Inventors: Yumi Yamamoto, Kakogawa-shi (JP); Tatsuki Yamamoto, Kakogawa-shi (JP)

Correspondence Address: SMITH PATENT OFFICE, 1901 PENNSYLVANIA AVENUE N W, SUITE 901, WASHINGTON, DC, 20006, US

(21) Appl. No.: 12/368,075

(22) Filed: Feb. 9, 2009

(30) Foreign Application Priority Data
Feb. 7, 2008 (JP) JP2008-027203
Oct. 7, 2008 (JP) JP2008-260350

(51) Int. Cl. A21D 2/36; A21D 8/00; A23L 2/52; A23L 1/05; A23L 1/105; A21D 13/00

(52) U.S. Cl. 426/21; 426/648; 426/572; 426/62; 426/64; 426/565; 426/569

(57) ABSTRACT

A diet food composition effective in prevention of lifestyle related diseases is disclosed. The composition comprises a soluble dietary fiber of 5 to 35 weight % mainly containing insulin and an insoluble dietary fiber of 95 to 65 weight %, selected from the group consisting of wheat bran, rice bran and soybean fiber. The insoluble dietary fiber and the soluble dietary fiber are mixed at a mixture ratio of 1 to 2-20 on the basis of weight portion. The composition per 100 kcal contains the dietary fiber of at least 10 grams and insulin of at least 2 grams. In a mixing process, the soluble dietary fiber can be previously mixed and whipped with water and oil before mixing with the insoluble dietary fiber and the gluten can be previously fermented before mixing with the insoluble dietary fiber in order to have a good finished product.

### BACKGROUND OF THE INVENTION

1. Field of the Invention

The invention is related to a diet food composition mainly consisting of a soluble dietary fiber and an insoluble dietary fiber, especially to a diet-food composition containing insulin extracted from rhizomes of Jerusalem artichokes. One use of the diet food composition is for recovering from a so-called lifestyle related disease. The inventive diet food composition can also applied to a pet-food composition.

2. Description of the Related Art

Recently, there is an increase of patients with so-called lifestyle related diseases including obesity, Diabetes Mellitus and dyslipidemia. We are focusing on a kind of soluble dietary fiber, containing insulin which can be extracted from rhizomes of Jerusalem artichokes (hereinafter simply called a Jerusalem artichoke) because of the effectiveness for prevention and improvement of lifestyle related diseases (reference to Non-Patent Document 1).

For example, it is proposed that a pasta compound can be prepared from a crushed paste of rhizomes of Jerusalem artichokes mixed with a wheat powder, a buckwheat powder or a rice powder (Patent Document 1).

However, the paste of rhizomes of Jerusalem artichokes does not have a good taste because it is bitter and the mainly contained insulin is not useful to be decomposed with ease by enzymes. Therefore, a variety of trials have been proposed in order to moderate the taste for improving a broader food application without decreasing the amount of insulin.

For example, if a Jerusalem artichoke is pickled in salt and then the salt content therein is removed for eating. After that, the Jerusalem artichoke is subjected to a drying process and a baking process to get a powder as a food composition (Patent Document 2). Further, a dried powder or dried extract from Jerusalem artichokes is mixed with a dried powder or extract essence of mulberry leaves to make a food powder (Patent Document 3). Furthermore, citric acid powder and vitamin E are added to a dried powder from Jerusalem artichokes and mixed with fillers in order to make a food tablet (Patent Document 4).

(Patent Document 1) Japanese Tokkai 07-155131

(Patent Document 2) Japanese Tokkai 04-51864

(Patent Document 3) Japanese Tokkai 2003-180293

(Patent Document 4) Japanese Tokkai 2002-000216

(Non-patent Document 1) Author Ichirou Yazawa; Protect your life from deadly quartet by Jerusalem artichokes [insulin] Published by Heart Publication 2003.

### SUMMARY OF THE INVENTION

In the methods described in the Patent Documents 1 to 4, there are some problems in difficult handling and the higher cost of additives and also a limited applied field, so that they are not always useful in practice.

Therefore, the inventors have tried to improve utilization of insulin and especially for Jerusalem artichoke dried powder containing insulin in broad fields of powder processed foods including breads, cakes, noodles such as udon and pasta, sweets, pizza, pancake, tako-balls and so on. As a result, the inventors have found that Jerusalem artichoke [insulin] is a typical soluble dietary fiber which is more useful for lifestyle related diseases by means of a combination with an insoluble dietary fiber selected from the group consisting of wheat bran, soybean fiber and rice bran in comparison with a single use of either a soluble dietary fiber or an insoluble dietary fiber. It has not been clear why the combination of a soluble dietary fiber and an insoluble dietary fiber is effective in the prevention against lifestyle related diseases. As a result of many tests, we speculate that, the soluble dietary fiber has a function to prevent absorption of the sugar content and decomposition of the sugar content at a position of the intestinal walls and also a function to discharge the sugar content together with the insoluble dietary fiber from a person's body. Therefore, the combination of a soluble dietary fiber and an insoluble dietary fiber may improve health by protecting a person's body against lifestyle related diseases such as obesity, Diabetes Mellitus and dyslipidemia in comparison with a single use of one of these types of fibers. It becomes clear that the combination is also effective for constipation.

Therefore, based on our above findings, a first object of the present invention is to provide a diet-composition comprising a combination of a soluble dietary fiber and an insoluble dietary fiber which is effective for treating lifestyle related diseases.

The first embodiment is to provide a diet-food and pet-food composition which comprises a powder of a soluble dietary fiber mainly containing insulin and a powder of an insoluble dietary fiber selected from the group consisting of wheat bran, rice bran and soybean fiber, wherein the insoluble dietary fiber and the soluble dietary fiber are mixed at a mixture ratio of 1 to 2-20 on the basis of a weight portion.

It has been known that a soluble dietary fiber mainly containing insulin has the same function as insulin through oral dosage, but it has not been known that the combination use of a soluble dietary fiber mainly containing insulin and an insoluble dietary fiber causes a favorable multiplier effect (synergistic effect) for preventing lifestyle related diseases. In a preferred embodiment of the invention, the insoluble dietary fiber may be mixed with the soluble dietary fiber of 2 to 20 times on the basis of weight portion. This is because the preferred multiplier effect can be obtained at a mixture ratio of 1 to 2 or more than 2 on the basis of weight portions and preferably 1 to more than 3 to 10 or less than 10. The upper limit of the mixture ratio should be at 1 to 20 on the basis of weight portions, considering good intake per day of insulin and total food.

In an another preferred embodiment, the inventive composition may contain total dietary fiber of at least 10 grams and insulin of at least 1 gram in the dietary fiber considering one food unit of 100 kcal. Therefore, from the aspect of the preferred embodiment, a diet food composition is able to be adjusted to 100 kcal (more or less) per one unit for a person having 60 to 65 kg body weight. The diet composition is useful for patients or candidates with lifestyle related diseases, because the diet composition gives them at least 10 grams of dietary fiber and at least 1 gram of insulin per one food unit of 100 kcal. Considering the standard intake of 2000 to 2500 kcal per day and 2.5 to 10 grams of insulin per day for a person having a 60 to 65 kg body weight, it is reasonable that the above composition contain total dietary fiber of at least 10 grams and insulin of at least 1 gram in the dietary fiber. A commercial powder of Jerusalem artichokes contains insulin of 40 to 50 weight % and mineral content for the remainder, so this powder is useful for a food material. According to the present invention, the combination use of a soluble dietary fiber and an insoluble dietary fiber also improves some patients' bowel movements, their skin condition and the smell of the bowels as well as the menstruation period in women. The diet composition is also useful as a diet pet food, which should be fed on the basis of the weight of the pet.

In the case of mixing the soluble dietary fiber mainly containing insulin with food powder and the insoluble dietary powder, it is difficult to make a dough that can be cooked, so a gluten content should be added as a binding material up to more than 15 to 100 weight % of the insoluble dietary fiber. Other binding materials may be used such as one selected from the group of wheat powder, rice powder, buckwheat powder, bean powder, corn powder, potato powder and soybean protein powder. In the case that the food composition contains glucide, the amount of insulin may be increased up to 1 to 2 grams per 10 grams of glucide.

Meanwhile, in the case that the diet food comprises the insoluble dietary fiber and the soluble dietary fiber, there is a problem that the taste is not good, so that it is recommendable to add gluten as a binding material. However, it has been found that the gluten tends not to make a uniform fermented texture by means of yeast under the condition of coexistence with the insoluble dietary fiber, because the fermenting condition is different from general condition where gluten is contained in wheat flour. We have found that the insoluble dietary fiber breaks the bubbles produced during the fermentation process and does not allow a uniform fermentation, which results in a product without good taste and without a good texture.

Therefore, a second object of the present invention is to provide a method of preparing a better tasting diet food.

According to the second aspect of the invention, there is provided a method of preparing a diet-food or pet-food comprising a soluble dietary fiber mainly containing insulin and an insoluble dietary fiber selected from the group consisting of wheat bran, rice bran and soybean fiber at a mixture ratio of 1 to 2-20 on the basis of weight portion, which comprises: providing a gluten texture made from a gluten powder with yeast, making a dough from the gluten texture mixed with a soluble dietary fiber and an insoluble dietary fiber, wherein the gluten texture of is mixed at 15 to 100 weight % on the basis of the insoluble dietary fiber, and fermenting uniformly the dough.

In a preferred embodiment, the gluten texture is mixed at a mixture ratio of 30 to 100 weight % on the basis of the insoluble dietary fiber. In the case of using another binding material together with the gluten, the gluten may be mixed with the dough comprising dietary fibers because the gluten texture can be produced in the dough from the gluten.

Furthermore, in the case of mixing the soluble dietary fiber mainly containing insulin with the insoluble dietary fiber, we found that the soluble dietary fiber should be whipped with oil and water to make a cream composition containing air bubbles before the soluble dietary fiber is mixed directly with the insoluble dietary fiber and water. This is because the soluble dietary fiber tends to absorb water content, resulting in an unbalanced water distribution and a poor taste. Therefore, in order to provide a better tasting diet composition as a third object of the present invention, there is provided a method of preparing a diet-food or pet-food comprising the soluble dietary fiber mainly containing insulin mixed with insoluble dietary fiber selected from the group consisting of wheat bran, rice bran and soybean fiber at a mixture ratio of 1 to 2-20 on the basis of weight portions, which comprises whipping at least a part of the soluble dietary fiber with water and oil to make a cream composition containing an air, mixing the cream composition containing the soluble fiber with the insoluble dietary fiber to get a dough, fermenting uniformly the dough and then baking the dough.

In the inventive method, the whipped cream composition is defined as the composition wherein the soluble dietary fiber contains some water enough to keep a balanced water content and is formed as a particle which is covered by an oil layer and between which particles there exist bubbles just like a whipped cream. In the whipped cream composition, it is believed that the oil outer layer of the soluble dietary fiber particle functions to shut out and avoid water over-absorption from the insoluble dietary fiber to the soluble dietary fiber so as to keep a good total water balance in the dough while the bubbles exist between the soluble dietary fiber particles and the insoluble dietary fiber functions to make water channels coming out from the dough during the baking process.

In a preferred embodiment, the soluble dietary fiber is mixed with the insoluble dietary fiber at the mixture ratio of 1 to 3-10 on the basis of a weight portion.

In this invention, as the soluble dietary fiber, insulin extracted from rhizomes of Jerusalem artichoke may be used. In the case of dried foods containing insulin extracted from chicory or a bread composition containing water, a dry powder of Jerusalem artichokes (hereinafter simply called an insulin powder) is better to use. The dry food powder is processed by means of freeze drying from a crush paste of Jerusalem artichokes.

In a preferred embodiment of the diet food composition, a mixture ratio of the soluble dietary fiber and insoluble dietary fiber should be 5 to 35 weight % to 95 to 65 weight % wherein the insoluble dietary fiber and the soluble dietary fiber are mixed at a mixture ratio of 1 to 2-20 on the basis of weight portion.

The composition is very effective in preventing and recovering from lifestyle related diseases, if the insulin powder is mixed at 5 to 35 weight % of the composition and the insoluble dietary fiber is mixed of 65 to 95 weight % of the composition. The synergism of the combination of the soluble dietary fiber and the insoluble dietary fiber can be shown if the insoluble dietary fiber and the soluble dietary fiber are mixed at a mixture ratio of 1 to 2-20 on the basis of weight portion.

In processed food such as bread, confections including cakes, pancakes, cereals, cookies, and so on, per 100 weight portion of the composition comprising the insulin powder and wheat bran there can be added wheat powder of 1 to 50 weight portions. In this case, gluten, maltose, salad oil, butter, egg, yeast, vanilla flavoring and so on may be added to the composition wherein it is better to add gluten of less than 25 weight % and maltose of less than 20 weight % of the composition.

In processed noodles such as udon noodles, pasta and buckwheat noodles, per 100 weight portions of the composition comprising the insulin powder and wheat bran, there is preferably added a wheat powder or buckwheat powder of 10 to 80 weight portions. In this case, the gluten may be added up to more than 15 weight % of the insoluble dietary fiber and the gluten texture may be formed separately from the insoluble dietary fiber.

In processed powder foods such as pizza, Japanese okonomiyaki and tako-balls, to a 100 weight portion of the composition comprising the insulin powder and wheat bran, there is preferably added a wheat powder of 5 to 80 weight portions. In processed powder foods such as hot-cakes, corn-caps, per 100 weight portions of the composition comprising the insulin powder and wheat bran, wheat powder is not added, if necessary, although preferably wheat powder is added in 5 to 80 weight portions. In this case, gluten, maltose, salad oil, butter, egg, yeast, vanilla flavoring and so on may be added to the composition. It is better to add gluten of less than 25 weight % and maltose of less than 30 weight % of the composition.

According to the desired foods, the inventive composition is processed in a conventional way, where the composition is mixed with a proper amount of water to make a dough and then is subjected to aging (including fermenting), molding, freezing, heat-processing (baking, boiling) and so on to obtain an insulin contained food.

For example, in the case of bread or pizza, the composition except gluten is mixed with water to obtain a dough while the gluten texture is separately made of gluten powder. Then, the gluten texture is mixed with the dough and the mixture is subjected to fermentation, molding and baking to obtain a finished food.

In case of a diet cereal food, the cereal composition is blended with water to make a dough and then the dough is baked. In this case, there is provided the cereal per 30 grams contains the dietary of at least 10 grams including at least insulin of 1 gram without addition of glucide or at least insulin of 2 grams with addition of glucine.

In the case of cakes and baked confectioneries, the composition is blended with water to make a dough, which is molded in a mold and subjected to baking to obtain a product having 100 kcal (more or less). For example, in case of a diet cookie, the composition may be prepared from the soluble dietary fiber of 5 to 35 weight % mainly containing insulin and the insoluble dietary fiber of 95 to 65 weight %, selected from the group consisting of wheat bran, rice bran and soybean fiber, wherein the insoluble dietary fiber and the soluble dietary fiber are mixed at a mixture ratio of 1 to 2-20 on the basis of weight portion, and mixed with a malt sugar, an oil component, a swelling agent, a flavoring agent to obtain a dough. The single cookie made from the dough is prepared to have at least 10 grams and insulin of at least 2 grams per 100 kcal.

In the case of cakes, the composition may be prepared from a soluble dietary fiber of 5 to 35 weight % mainly containing insulin and an insoluble dietary fiber of 95 to 65 weight %, selected from the group consisting of wheat bran, rice bran and soybean fiber, wherein the insoluble dietary fiber and the soluble dietary fiber are mixed at a mixture ratio of 1 to 2-20 on the basis of weight portions, and mixed with a wheat powder, a malt sugar, a milk component, a swelling agent and a flavoring agent to obtain a dough. A single cookie made from the dough is prepared to have at least 10 grams and insulin of at least 2 grams per 100 kcal.

In case of a diet doughnut, the composition comprising a soluble dietary fiber of 5 to 35 weight % mainly containing insulin and an insoluble dietary fiber of 95 to 65 weight %, selected from the group consisting of wheat bran, rice bran and soybean fiber, wherein the insoluble dietary fiber and the soluble dietary fiber are mixed at a mixture ratio of 1 to 2-20 on the basis of weight portions, and mixed with a gluten texture fermented with yeast to obtain a dough. The single doughnut made from the dough is prepared to have at least 10 grams and insulin of at least 2 grams per 100 kcal.

In case of diet ice cream, the composition comprising a soluble dietary fiber of 5 to 35 weight % mainly containing insulin and an insoluble dietary fiber of 95 to 65 weight %, is mixed with proper ice cream compounds. The resulting ice-cream product contains the dietary fiber of at least 10 grams and insulin of at least 2 grams per 100 kcal. Similarly, in case of diet ice cream, the composition comprising a soluble dietary fiber of 5 to 35 weight % mainly containing insulin and an insoluble dietary fiber of 95 to 65 weight %, is mixed with proper additives. The resulting product contains the dietary fiber of at least 10 grams and insulin of at least 2 grams per 100 kcal.

In the case of noodles such as udon noodles, buckwheat noodles and pasta, it is recommended that the composition except for gluten is blended with water to make a dough while a gluten texture is made from a gluten powder. The dough is mixed with the gluten texture and the mixture compound is molded and drawn or cut and subjected to boiling to get a boiled product.

In the case of insulin powder from rhizomes of Jerusalem artichokes, it is preferred that it is subjected to a cooling or freezing process during one or more of the processes, because the cooling process moderately omits the bitter taste.

In the case of pet foods, the same composition as that for humans may be used and it is preferred that the sweet content may be decreased in comparison to human diet food. Therefore, in a preferred embodiment, the pet food can be prepared based on the same menu as the human cereal composition with the addition of taste and necessary content according to the rules of pet food.

According to the present invention, it is apparent that a determined mixture ratio of the soluble dietary fiber and the insoluble dietary fiber causes a synergetic effect for lifestyle related diseases, for example, a determined mixture of the insulin powder and wheat bran moderates the bitter taste of the Jerusalem artichoke. Further, coexistence of the soluble dietary fiber and insoluble dietary fiber causes the same effect as insulin by oral dosage of the soluble dietary fiber mainly containing insulin and also the synergetic effect together with the insoluble dietary fiber of wheat bran and so on, resulting in good prevention of lifestyle related diseases and good improvement in health. Therefore, the composition according to the present invention is useful for a diet food that helps to prevent lifestyle related diseases.

Further, in a process of making the diet food that comprises the soluble dietary fiber and the insoluble dietary fiber according to the present invention, the soluble dietary fiber is mixed and whipped with water and oil to form a whipped cream composition before mixing it with the insoluble dietary fiber, so that mixture of the soluble dietary fiber and the insoluble dietary fiber get a good water balanced content, resulting in a good finished product.

Furthermore, in the case of using gluten as a binding material between the soluble dietary fiber and the insoluble dietary fiber, a gluten texture is previously fermented from gluten before it is mixed with the insoluble dietary fiber, so that the gluten texture is completed to have a good bubble total distribution without fermentation damage caused by the insoluble dietary fiber, resulting in a good finished product.

### BRIEF DESCRIPTION OF THE DRAWINGS

FIG. 1 is a photograph showing a sectional view having a good bubble distribution in the bread made according to the present invention.

FIG. 2 is a photograph showing a sectional view of a bubble distribution in bread made according to a conventional method.

### DETAILED DESCRIPTION OF THE PREFERRED EMBODIMENTS

The present invention will be explained in more detail according to the following embodiments and the attached drawings.

### EXAMPLE 1

Freeze-dried insulin powder of 15 weight portions, wheat bran powder of 55 weight portions and wheat germ of 5 weight portions are mixed with water to make a dough composition. On the other side, gluten powder of 15 weight portions, wheat powder of 10 weight portions and maltose of 5 weight portions are blended to make a gluten composition.

To the dough composition of 100 weight portions, salt of 0.1 weight portion, butter of 10 weight portions and water of a proper amount are added and they are mixed to make a dough, while to the gluten composition, yeast powder is added and they are mixed to form a gluten texture.

Then the dough and the gluten texture are mixed and molded by a conventional way and fermented for 40 to 60 minutes at a temperature of 35 to 40° C. and baked at 190° C. to get a bread. The resulting bread per 100 kcal contains dietary fiber of 10 grams and insulin of 2 grams.

On the other hand, freeze dried insulin powder of 15 weight portions, a wheat bran powder of 55 weight portions and a wheat germ of 5 weight portions and a gluten powder of 15 weight portions, a wheat powder of 10 weight portions and maltose of 5 weight portions are mixed at once together with water to make a dough. The dough is molded in a conventional way and fermented for 40 to 60 minutes at a temperature of 35 to 40° C. and baked at 190° C. to get a bread. The resulting bread per 100 kcal contains dietary fiber of 10 grams and insulin of 2 grams.

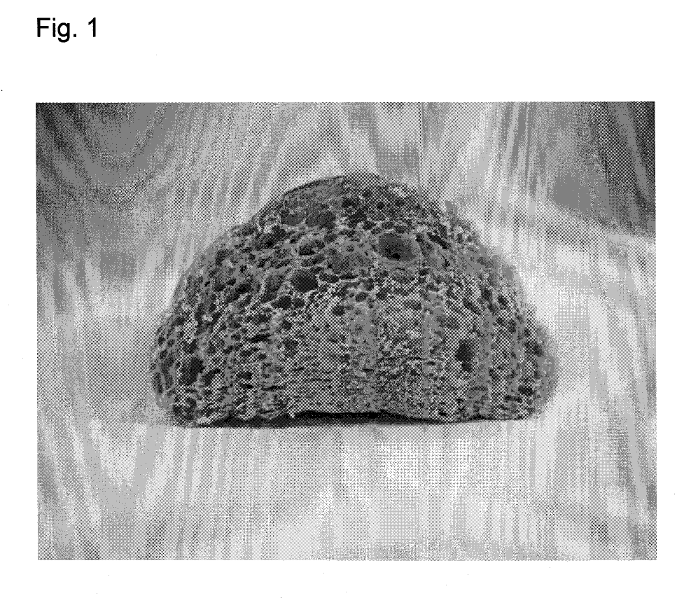

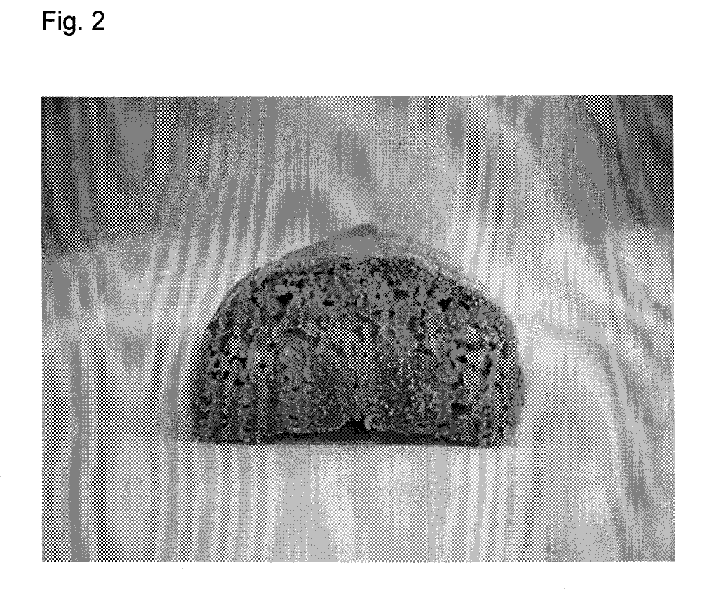

Comparing the former product with the latter product, the former product has a uniformly foamed gluten texture fermented by yeast as shown in FIG. 1, while the latter product does not have a uniformly foamed gluten texture fermented by yeast as shown in FIG. 2 where some foams of the gluten texture are broken so that different sized foams, large and small, exist in the gluten texture. Therefore, it has been confirmed that the eating taste of the former product is better than that of the latter.

According to the present invention, the resulting bread will keep for a long time under frozen conditions and it is able to be defrosted and eaten as it is or after toasting.

### EXAMPLE 2

Wheat flour of 25 weight portions, freeze dried insulin powder of 15 weight portions and wheat bran powder of 60 weight portions are mixed to have a cereal composition.

To the cereal composition a proper amount of water is added and mixed to make a dough, which is molded and baked for 3 minutes at 230° C. to get a cereal product. The resulting cereal contains dietary fiber of 10 grams and insulin of 2 grams per 100 kcal of cereal.

### EXAMPLE 3

Wheat flour of 5 weight portions, freeze dried insulin powder of 15 weight portions and wheat bran powder of 80 weight portions are mixed to have a sponge cake composition.

To the sponge cake composition a proper amount of water is added and mixed to make a dough, which is molded and baked for 20 minutes at 210° C. to get a sponge cake product. The resulting sponge cake product contains dietary fiber of 10 grams and insulin of 2 grams per 100 kcal of cereal.

### EXAMPLE 4

To wheat bran powder of 65 weight portions, water or milk of the same weight as that of the wheat bran is added and mixed to make a wheat bran paste. On the other hand, freeze dried insulin powder of 15 weight portions, maltose of 15 to 20 weight portions and butter of 25 weight portions and water of 30 weight portions are mixed together and whipped to make a whipped composition. The wheat bran paste is mixed with the whipped composition and whipped again. The resulting whipped dough are molded by a conventional way and baked for 30 minutes at 210° C. to get a cookie. The resulting cookie per 100 kcal contains dietary fiber of 10 grams and insulin of 2 grams.

### EXAMPLE 5

Wheat flour for udon of 30 weight portions, freeze dried insulin powder of 15 weight portions, and wheat bran powder of 50 weight portions are mixed with water to make a dough composition. On the other side, gluten powder of 15 weight portions is blended to make a gluten texture. The dough composition and the gluten texture are mixed to make an udon composition. To the udon composition of 100 weight portions, salt and water of a proper amount are added and they are mixed to have a dough. Then the udon dough is molded and cut by a conventional way and boiled to get an udon product. The resulting udon per 100 kcal contains dietary fiber of 10 grams and insulin of 2 grams.

### EXAMPLE 6

Wheat flour for 35 weight portions, freeze dried insulin powder of 15 weight portions, wheat bran powder of 45 weight portions and yam powder of 5 weight portions are mixed with water to make a composition for Japanese okonomiyaki. The composition and water are mixed to make a paste which is molded and topping materials are topped and baked to get an okonomiyaki product. The resulting okonomiyaki (except the topping materials) per 100 kcal contains dietary fiber of 10 grams and insulin of 2 grams.

### EXAMPLE 7

Freeze dried insulin powder of 20 weight portions is added to a boiling water of 20 ml and mixed to a cream composition. On the other hand, butter or margarine of 60 weight portion was melted, to which maltose of 70 weight portions and freeze dried insulin powder of 30 weight portions are added and whipped until the whipped composition becomes white. To the whipped composition, soybean fiber paste of 250 weight portions is added and stirred until the whipped composition gets sufficient bubbles. Finally, to the latter whipped composition, the former whipped liquid composition is added and whipped well again to get a dough. The dough is molded and baked to get a soybean fiber cookie. The resulting fiber cookie has a uniform foam and a good taste.

The resulting bread of 60 grams has 100 kcal and contains dietary fiber of 10 grams and insulin of 2 grams. The resulting cookie of 30 grams or 100 kcal contains dietary fiber of 10 grams and insulin of 2 grams. They were administered to patients with lifestyle related diseases instead of a part or whole nutrition controlled meal and their condition was checked. It was confirmed that the lifestyle related disease was improved. We understand that the inventive diet composition per one unit can give us 100 to 30% of the necessary dietary fiber per one day as determined by the Japanese Ministry of Health and Welfare.

### (Test Case 1)

To a 40 year old man having a neutral fat level of 225 mg/dL and a blood sugar level of 121 mg/dL, instead of ordinary food, the inventive bread of 60 grams having 100 kcal, dietary fiber of 10 grams and insulin of 2 grams is given one time or the cereal or cookie of 30 grams having 100 kcal, dietary fiber of 10 grams and insulin of 2 grams is given two times. After 6 months, the neutral fat level decreased to 80 and the blood sugar level decreased to 82.

### (Test Case 2)

To a 57 year old woman having a blood sugar level of 225 mg/dL, instead of ordinary food, the inventive bread of 60 grams having 100 kcal, dietary fiber of 10 grams and insulin of 2 grams is given one time and the cereal or cookie of 30 grams having 100 kcal, dietary fiber of 10 grams and insulin of 2 grams is given two times. After 7 days, her blood sugar level decreased to 136.

### (Test Case 3)

To a 78 year old woman having a blood sugar level of 160 mg/dL, instead of ordinary food, the inventive bread of 60 grams having 100 kcal, dietary fiber of 10 grams and insulin of 2 grams is given one time and the cereal or cookie of 30 grams having 100 kcal, dietary fiber of 10 grams and insulin of 2 grams is given two times. After 7 days, her blood sugar level decreased to about 100.

### (Test Case 4)

To a 37 year old woman having a body fat percentage of 32%, one of the above breads was given together with ordinary food every breakfast and dinner. After 2 months, her body fat percentage decreased to 28%. After 5 months, her body fat percentage decreased to 26.5%. Her constipation and skin color were improved and physiological period became steady.

### (Test Case 5)

To a 66 year old woman having a body fat percentage of 32%, the above cereal was given instead of ordinary food and sometimes together with ordinary food 2 times per day. After 45 days, her body fat percentage decreased to 23%.

### (Test Case 6)

To a 40 year old man, the above bread of 60 grams having 100 kcal, dietary fiber of 10 grams and insulin of 2 grams was given instead of ordinary food two times per day. After 2 months, HDL-cholesterol value increased and total cholesterol decreased to a normal value.

### (Test Case 7)

To a 49 year old man, the above bread of 60 grams having 100 kcal, dietary fiber of 10 grams and insulin of 2 grams was given two times per day together with ordinary food. After 2 months, hemoglobin Alc decreased to a normal value.

### (Test Case 8)

To a 50 year old man, the above cereal of 30 grams having 100 kcal, dietary fiber of 10 grams and insulin of 2 grams was given instead of ordinary food two times per day. After 2 months, his neutral fat value decreased to 58 mg/dL from 175 mg/dL.

### (Test Case 9)

To a 28 year old man, the above bread of 60 grams having 100 kcal, dietary fiber of 10 grams and insulin of 2 grams was given at dinner per day together with ordinary food. After 1 month, his body weight decreased to 81.4 kg from 85.5 kg without any special exercise program.

### (Test Case 10)

To a 78 year old diabetic woman who needs to administer insulin, the above bread was given two times per day together with ordinary food. After one week or less, her blood sugar level decreased to a normal level and became steady.

As apparent from the above description, the inventive composition comprising soluble dietary fiber mainly containing insulin and the insoluble dietary fiber is effective to prevent and recover from lifestyle related diseases including corpulence, diabetes and so on. Therefore, the present invention can be applied to a variety of wheat powder food including bread, confections including cakes, pancakes, cereals, cookies, and so on, as well as diet ice cream and diet drinks.

The present application claims priority to Japanese Patent Application No. 2008-27203 filed Feb. 7, 2008 and to Japanese Patent Application No. 2008-260350 filed Oct. 7, 2008, the contents of which are incorporated herein by reference.

What is claimed is:

1. A diet food and pet food composition which comprises a soluble dietary fiber mainly containing insulin and an insoluble dietary fiber selected from the group consisting of wheat bran, rice bran and soybean fiber, wherein the insoluble dietary fiber and the soluble dietary fiber are mixed at a mixture ratio of 1 to 2-20 on a basis of weight portions.

2. A diet food and pet food composition according to claim 1, wherein at least a part of the soluble dietary fiber is in a form of an air containing cream composition with water and oil whipped to contain air and said cream composition being mixed with the insoluble dietary fiber.

3. A diet food and pet food composition according to claim 1, wherein the composition per about 100 kcal contains total dietary fiber of at least 10 grams and the insulin of at least 1 gram.

4. A diet food and pet food composition according to claim 1, wherein the powder of insoluble dietary fiber contains a binding material of 15 to 100 weight % of the insoluble dietary fiber, the binding material being selected from the group of wheat powder, gluten, powder, rice powder, buckwheat powder, bean powder, corn powder, potato powder and soybean protein powder and the insulin is adjusted according to the increased amount of glucide.

5. A diet food and pet food composition according to claim 1, wherein the composition contains gluten in a form of fermented gluten texture.

6. A diet food and pet food composition according to claim 1, wherein the soluble dietary fiber mainly containing insulin contains a soluble dietary component extracted from chicory or insulin extracted from rhizomes of Jerusalem artichokes.

7. A diet food and pet food composition according to claim 1, wherein said composition is a bread composition which comprises a dough including a soluble dietary fiber of 5 to 35 weight % mainly containing insulin and an insoluble dietary fiber of 95 to 65 weight %, wherein the insoluble dietary fiber and the soluble dietary fiber are mixed at a mixture ratio of 1 to 2-20 on a basis of weight portions, and including a gluten texture compound containing yeast.

8. A diet food and pet food composition according to claim 1, wherein said composition is a pasta composition which comprises a dough including a soluble dietary fiber of 5 to 35 weight % mainly containing insulin and an insoluble dietary fiber of 95 to 65 weight %, wherein the insoluble dietary fiber and the soluble dietary fiber are mixed at a mixture ratio of 1 to 2-20 on a basis of weight portions, and mixed with a gluten texture compound.

9. A diet food and pet food composition according to claim 1, wherein said composition is a cereal composition which comprises a powder material comprising a soluble dietary fiber of 5 to 35 weight % mainly containing insulin and an insoluble dietary fiber of 95 to 65 weight %, wherein the insoluble dietary fiber and the soluble dietary fiber are mixed at a mixture ratio of 1 to 2-20 on the basis of weight portion, and mixed with or without a wheat powder, wherein the compound calories per 30 grams is adjusted to about 100 kcal.

10. A diet food and pet food composition according to claim 9, wherein the cereal per 30 grams contains the dietary fiber of at least 10 grams including at least insulin of 1 gram without addition of glucide or at least insulin of 2 grams with an addition of glucine.

11. A diet food and pet food composition according to claim 1, wherein said composition is a cookie composition wherein said composition is a bread composition which comprises a powder material comprising a soluble dietary fiber of 5 to 35 weight % mainly containing insulin and an insoluble dietary fiber of 95 to 65 weight %, wherein the insoluble dietary fiber and the soluble dietary fiber are mixed at a mixture ratio of 1 to 2-20 on a basis of weight portions, and combined with a malt sugar, an oil component, a swelling agent, a flavoring agent wherein the compound per 100 kcal contains the dietary fiber of at least 10 grams and insulin of at least 2 grams.

12. A diet food and pet food composition according to claim 1, wherein said composition is a cake composition which comprises a powder material comprising a soluble dietary fiber of 5 to 35 weight % mainly containing insulin and an insoluble dietary fiber of 95 to 65 weight %, wherein the insoluble dietary fiber and the soluble dietary fiber are mixed at a mixture ratio of 1 to 2-20 on a basis of weight portions, and combined with a wheat powder, a malt sugar, a milk component, a swelling agent and a flavoring agent wherein the powder material per 100 kcal contains the dietary fiber of at least 10 grams and insulin of at least 2 grams.

13. A diet food and pet food composition according to claim 1, wherein said composition is a doughnut composition which comprises a powder material comprising a soluble dietary fiber of 5 to 35 weight % mainly containing insulin and an insoluble dietary fiber of 95 to 65 weight %, wherein the insoluble dietary fiber and the soluble dietary fiber are mixed at a mixture ratio of 1 to 2-20 on the basis of weight portion, and combined with a gluten texture fermented with yeast, wherein the powder material per 100 kcal contains the dietary fiber of at least 10 grams and insulin of at least 2 grams.

14. A diet food and pet food composition according to claim 1, wherein said composition is an ice cream composition which comprises a soluble dietary fiber of 5 to 35 weight % mainly containing insulin and an insoluble dietary fiber of 95 to 65 weight %, wherein the composition per 100 kcal contains the dietary fiber of at least 10 grams and insulin of at least 2 grams.

15. A diet food and pet food composition according to claim 1, wherein said composition is a drink composition which comprises a soluble dietary fiber of 5 to 35 weight. % mainly containing insulin and an insoluble dietary fiber of 95 to 65 weight %, wherein the composition per 100 kcal contains the dietary fiber of at least 10 grams and insulin of at least 2 grams.

16. A method of preparing a diet food or pet food composition comprising a soluble dietary fiber mainly containing insulin and an insoluble dietary fiber selected from the group consisting of wheat bran, rice bran and soybean fiber at a mixture ratio of 1 to 2-20 on a basis of weight portions, which comprises:
providing a fermented gluten composition made from gluten powder with yeast, making a dough from the fermented gluten composition by mixing with a soluble dietary fiber and an insoluble dietary fiber, wherein the gluten composition is mixed at 15 to 100 weight % on a basis of the insoluble dietary fiber, and fermenting uniformly the dough.

17. A method of preparing a diet food or pet food composition according to claim 16, wherein the gluten texture is mixed at a mixture ratio of 30 to 100 weight % on the basis of the insoluble dietary fiber.

18. A method of preparing a diet food or pet food composition which comprises a soluble dietary fiber mainly containing insulin mixed with an insoluble dietary fiber selected from the group consisting of wheat bran, rice bran and soybean fiber at a mixture ratio of 1 to 2-20 on a basis of weight portions, which comprises:
whipping at least a part of the soluble dietary fiber with water and oil to make a cream composition containing an air,
mixing the cream composition containing the soluble fiber with the insoluble dietary fiber to form a dough,
fermenting uniformly the dough, and
baking the dough.

19. A method of preparing a diet-food or pet-food according to claim 18, wherein the soluble dietary fiber is mixed with the insoluble dietary fiber at the mixture ratio of 1 to 3-10 on a basis of weight portions.
